(19) United States
(12) Patent Application Publication
(10) Pub. No.: US 2025/0265392 A1
(43) Pub. Date: Aug. 21, 2025

(54) METHOD AND APPARATUS FOR CONSTRUCTING DIGITAL TWIN HYBRID MODEL OF MAIN DEVICE OF POWER SYSTEM

(71) Applicant: CHINA ELECTRIC POWER RESEARCH INSTITUTE, Beijing (CN)

(72) Inventors: Xin ZHANG, Beijing (CN); Ling LI, Beijing (CN); Zhe LI, Beijing (CN); Xiaomeng DI, Beijing (CN); Tianyi ZHAI, Beijing (CN); Tianhang HUANG, Beijing (CN); Zhipeng WANG, Beijing (CN); Zheng LI, Beijing (CN)

(21) Appl. No.: 18/859,575

(22) PCT Filed: Sep. 11, 2023
(86) PCT No.: PCT/CN2023/118086

§ 371 Date: Oct. 24, 2024

(30) Foreign Application Priority Data
Nov. 14, 2022 (CN) 202211417073.1

(51) Int. Cl. G06F 30/27; G06F 113/04

(52) U.S. Cl. CPC G06F 30/27; G06F 2113/04

(57) ABSTRACT

Disclosed in the present invention are a method and apparatus for constructing a digital twin hybrid model of a main device of a power system. The method comprises: performing information coding on an operation state and fault association knowledge graph of a main device of a power system to generate a density vector; embedding the density vector into a first layer of a ConvGRU neural network for performing initial training of a data-driven model to obtain a data-driven initial model; optimizing a convolutional base and a classifier of the data-driven initial model by means of historical collected data to obtain an optimized data-driven model; and enabling the data-driven model and a mechanism model of the main device of the power system to cooperatively operate in parallel, and performing gradient descent of a loss function of the neural network by means of a solver, so as to construct a digital twin hybrid model of the main device of the power system.

### CROSS-REFERENCE TO RELATED APPLICATIONS

This application is based on and claims the priority of the Chinese patent application with the application Ser. No. 202211417073.1 and the filing date of Nov. 14, 2022, the entire content of which is incorporated herein by reference.

### TECHNICAL FIELD

The present disclosure relates to the technical field of power system, and more particularly, to a method and an apparatus for constructing a digital twin hybrid model of a power system main device.

### BACKGROUND

At present, for simulation modeling of a power grid device, there is a digital twin hybrid model, which includes three types: a serial form, a parallel form, and a tight-coupling form. 1. Construction of a hybrid model based on the serial form: there may be a magnitude difference between input data of a data-driven model and input data of a mechanism model, and in this case, it is necessary to estimate an intermediate value of the data, but it is usually difficult to determine the intermediate value, thereby limiting the accuracy of actual modeling. 2. Construction of a hybrid model based on the parallel form: a data-driven model does not learn the underlying dynamics, but predicts only the degree of mismatch between the mechanism model and the reality, so that although the modeling method can improve the degree of fitting of data to some extent, the practical application range thereof is very limited. Generally, the modeling method can only be used on the basis of a simple system. 3. Construction of a hybrid model based on the tight-coupling form: the method does not embed a priori knowledge base, and has the problems of difficulty in converging during training and the low modeling success rate. Therefore, the existing power grid device simulation modeling has the technical problems of low modeling precision and the low modeling success rate.

### SUMMARY

In view of the deficiencies of the prior art, the present disclosure provides a method and apparatus for constructing a digital twin hybrid model of a power system main device.

According to an aspect of the present disclosure, a method for constructing a digital twin hybrid model of a power system main device is provided, which includes the following operations.

A density vector is generated by encoding information of a knowledge graph of associations between operating states and faults of a power system main device.

The density vector is embedded into a first layer of a ConvGRU network to perform initial training of a data-driven model to obtain an initial data-driven model.

A convolutional base and a classifier of the initial data-driven model are optimized by using historical collected data to obtain an optimized data-driven model.

The data-driven model and a mechanism model of the power system main device are caused to operate cooperatively in parallel, and a gradient descent of a neural network loss function is performed by using a solver to construct a digital twin hybrid model of the power system main device.

Optionally, the method further includes that:
a knowledge base of operating states of the power system main device, a knowledge base of fault accidents of the power system main device, and a knowledge base of intrinsic associations between operating states and fault accidents of the power system main device are fused to form a knowledge graph of associations between the operating states and faults.

Optionally, the operation that the density vector is embedded into a first layer of a ConvGRU network to perform initial training of a data-driven model to obtain an initial data-driven model, includes that:
the density vector is embedded into the first layer of the ConvGRU neural network by using a ComplEx embedding model to perform the initial training of the data-driven model to obtain the initial data-driven model.

Optionally, the operation that a convolutional base and a classifier of the initial data-driven model are optimized by using historical collected data to obtain an optimized data-driven model, includes that:
the historical collected data is preprocessed, and the historical collected data is divided into a training set and a validation set based on a preset ratio; and
the convolutional base and the classifier of the initial data-driven model are optimized by using the training set, and a validation is performed by using the validation set to construct the data-driven model.

Optionally, the method further includes that:
a shape parameter of each device in the mechanism model is corrected based on actually measured parameters of the power system main device; and
each internal parameter in the mechanism model is corrected based on the each actually measured parameters, herein the internal parameters includes an iron core full current of an oil-filled distribution transformer, a clamp grounding current, a transformer insulation bushing capacitance, a dielectric loss factor, and error rates of a gas sensor, an oil chromatograph, and a temperature sensor.

According to another aspect of the present disclosure, an apparatus for constructing a digital twin hybrid model of a power system main device is provided, which includes a generating module, a training module, an optimization module and a constructing module.

The generating module is configured to generate a density vector by encoding information of a knowledge graph of associations between operating states and faults of a power system main device.

The training module is configured to embed the density vector into a first layer of a ConvGRU network to perform initial training of a data-driven model to obtain an initial data-driven model.

The optimization module is configured to optimize a convolutional base and a classifier of the initial data-driven model by using historical collected data to obtain an optimized data-driven model; and
The constructing module is configured to cause the data-driven model and a mechanism model of the power system main device to operate cooperatively in parallel, and perform a gradient descent of a neural network loss function by using a solver to construct a digital twin hybrid model of the power system main device.

According to another aspect of the present disclosure, a computer-readable storage medium is provided, herein, the storage medium stores a computer program, and the computer program is used to perform the method according to any one of the above aspects of the present disclosure.

According to another aspect of the present disclosure, an electronic device is provided, which includes: a processor; and a memory for storing instructions executable by the processor, the processor being used to read the executable instructions from the memory and execute the instructions to implement the method according to any one of the above aspects of the present disclosure.

Therefore, for constructing the digital twin hybrid model on the basis of the embedding of the knowledge bases of the power system main device, that is, during the construction of the data-driven model using collected data: the knowledge base of the oil-filled distribution transformer is converted into the density vector first, and the density vector is embedded into the first layer of the ConvGRU network to complete model pre-training; and then the convolutional base and the classifier of pre-trained data are fine-tuned on the basis of the historical collected data; finally, the data-driven model and the mechanism model are solved in the solver to determine the digital twin hybrid model. The modeling method can fit the associations between any operating states and fault phenomena, thereby forming an effective complement to the mechanism model, and improving modeling precision by expanding a modeling range. The convolutional base and the classifier are fine-tuned by using the historical collected data, thereby improving the success rate of construction of the data-driven model. The method for constructing the hybrid model on the basis of the ConvGRU neural network comprises associations between implicit features in collected data of device and fault phenomena, thereby improving the dynamic inference capability of the digital twin system in a multi-space multi-scenario within a range of conditions for probability distributions covered by the data.

### BRIEF DESCRIPTION OF THE DRAWINGS

The accompanying drawings here are incorporated into the specification, constitute a part of the specification, illustrate embodiments compliant with the present disclosure, and are used with the specification to describe the technical solutions of the present disclosure.

FIG. 1 is a schematic flowchart of a method for constructing a digital twin hybrid model of a power system main device according to an exemplary embodiment of the present disclosure;

FIG. 2 is another schematic diagram of constructing a digital twin hybrid model on the basis of embedding of knowledge bases of a power system main device according to an exemplary embodiment of the present disclosure;

FIG. 3 is a schematic knowledge graph of overhead transmission line operating states and faults according to an exemplary embodiment of the present disclosure;

FIG. 4 is another schematic diagram of operations of constructing a digital twin hybrid model according to an exemplary embodiment of the present disclosure;

FIG. 5 is a schematic structural diagram of an apparatus for constructing a digital twin hybrid model of a power system main device according to an exemplary embodiment of the present disclosure; and

FIG. 6 is a structure of an electronic device according to an exemplary embodiment of the present disclosure.

### DETAILED DESCRIPTION

Exemplary embodiments of the present disclosure will be described in detail below with reference to the accompanying drawings. Apparently, the described embodiments are merely a part of rather than all of the embodiments of the present disclosure, and it should be understood that the present disclosure is not limited by the exemplary embodiments described herein.

It should be noted that: the relative arrangement of components and operations, numerical expressions, and numerical values set forth in these embodiments do not limit the scope of the present disclosure unless specifically stated otherwise.

It should be understood by those skilled in the art that the terms “first”, “second” and the like in the embodiments of the present disclosure are only used to distinguish different operations, devices, modules, or the like, do not represent any specific technical meaning, and do not represent any necessary logical order therebetween.

It should also be understood that in the embodiments of the present disclosure, “a plurality” may mean two or more, and “at least one” may mean one, two, or more.

It should also be understood that any component, data, or structure mentioned in the embodiments of the present disclosure may be generally understood as one or more components, pieces of data, or structures, unless explicitly defined otherwise or indicated otherwise in the context.

In addition, in the present disclosure, the term “and/or” is merely to describe the associations of associated objects, indicating that there may be three kinds of relationships. For example, A and/or B may indicate three situations: i.e., A exists alone, A and B exist simultaneously, or B exists alone. In addition, the character “/” in the present disclosure generally indicates that the associated objects before and after this character are in an “or” relationship.

It should also be understood that the description of the various embodiments of the present disclosure emphasizes the differences between the various embodiments. For the same or similar parts of the embodiments, reference may be made to the embodiments mutually. For simplicity, details are not repeatedly described herein.

Meanwhile, it should be understood that the sizes of various parts illustrated in the drawings are not drawn in an actual proportional relationship for convenience of description.

The following description of at least one exemplary embodiment is merely illustrative in nature and is in no way intended as any limitation on the present disclosure and applications or uses thereof.

The techniques, methods, and devices known to those of ordinary skill in the related art may not be discussed in detail, but should be considered part of the specification, where appropriate.

It should be noted that: like numbers and letters refer to like items in the following drawings, and thus, once a certain item is defined in a drawing, it does not need to be further discussed in subsequent drawings.

The embodiments of the present disclosure may be applied to electronic devices, such as terminal devices, computer systems, servers, etc., which are operational with numerous other general purpose or special purpose computing system environments or configurations. Examples of well-known terminal devices, computing systems, environments, and/or configurations that are suitable for use with electronic devices such as terminal devices, computer systems, servers, and like include, but are not limited to: personal computer systems, server computer systems, thin clients, thick clients, hand-held or laptop devices, microprocessor-based systems, set-top boxes, programmable consumer electronics, network personal computers, small computer systems, large computer systems, distributed cloud computing technology environments including any one of the above systems, and the like.

The electronic device, such as a terminal device, a computer system, a server, or the like, may be described in the general context of computer system executable instructions (such as program modules) executed by a computer system. Generally, a program module may include a routine, a program, an object program, a component, logic, a data structure, etc., that perform a particular task or implement a particular abstract data type. The computer system/server may be implemented in a distributed cloud computing environment where tasks are performed by remote processing devices that are linked through a communication network. In a distributed cloud computing environment, program modules may be located on local or remote computing system storage media including storage devices.

### Exemplary Methods

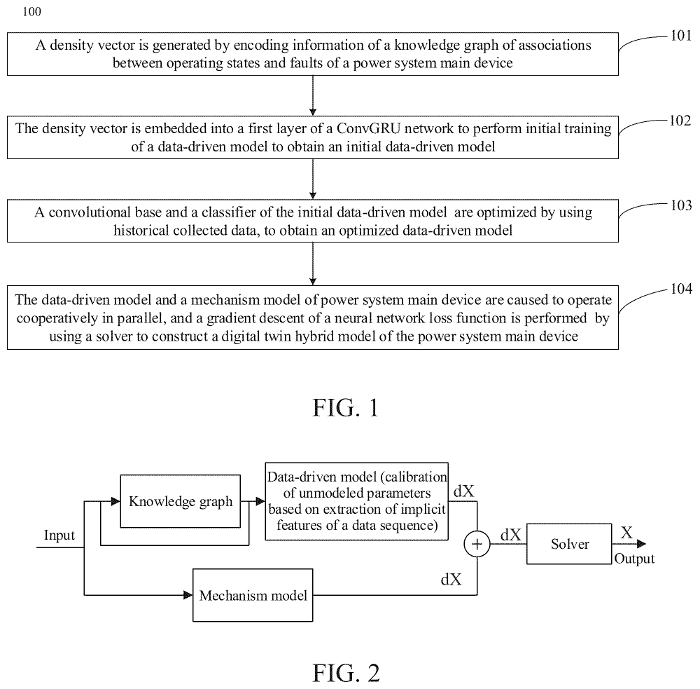

FIG. 1 is a schematic flowchart of a method for constructing a digital twin hybrid model of a power system main device according to an exemplary embodiment of the present disclosure. The present embodiment may be applied to an electronic device. As shown in FIG. 1 and FIG. 2, a method 100 for constructing a digital twin hybrid model of a power system main device includes the following operations:

In operation 101, a density vector is generated by encoding information of a knowledge graph of associations between operating states and faults of a power system main device.

In operation 102, the density vector is embedded into a first layer of a ConvGRU network to perform initial training of a data-driven model, to obtain an initial data-driven model.

Optionally, the operation that the density vector is embedded into a first layer of a ConvGRU network to perform initial training of a data-driven model to obtain an initial data-driven model, includes that:
the density vector is embedded into the first layer of the ConvGRU neural network by using a ComplEx embedding model to perform the initial training of the data-driven model to obtain the initial data-driven model.

Optionally, the method further includes that:
a knowledge base of operating states of the power system main device, a knowledge base of fault accidents of the power system main device, and a knowledge base of intrinsic associations between operating states and fault accidents of the power system main device are fused to form a knowledge graph of associations between the operating states and faults.

Specifically, typical power system knowledge bases include:
1. A knowledge base of operating states, which includes: the device state of the power system device analyzed by statistical method under disaster weathers such as thunder and lightning, strong winds, etc.,; a mapping relationship between different meteorological conditions and device states; and spatial-temporal distribution characteristics of internal defects and external hazards of a novel power system device in non-disaster meteorological conditions.
2. A knowledge base of fault accidents: spatial-temporal distribution characteristics of different types of faults studied through fault association factor mine on the basis of historical fault data of the power system device.
3. A knowledge base of intrinsic associations between operating states and fault accidents, which includes: an association between device operating states and fault accidents, manifestations of various fault features, and tracing and reasoning of sources of various fault accidents.

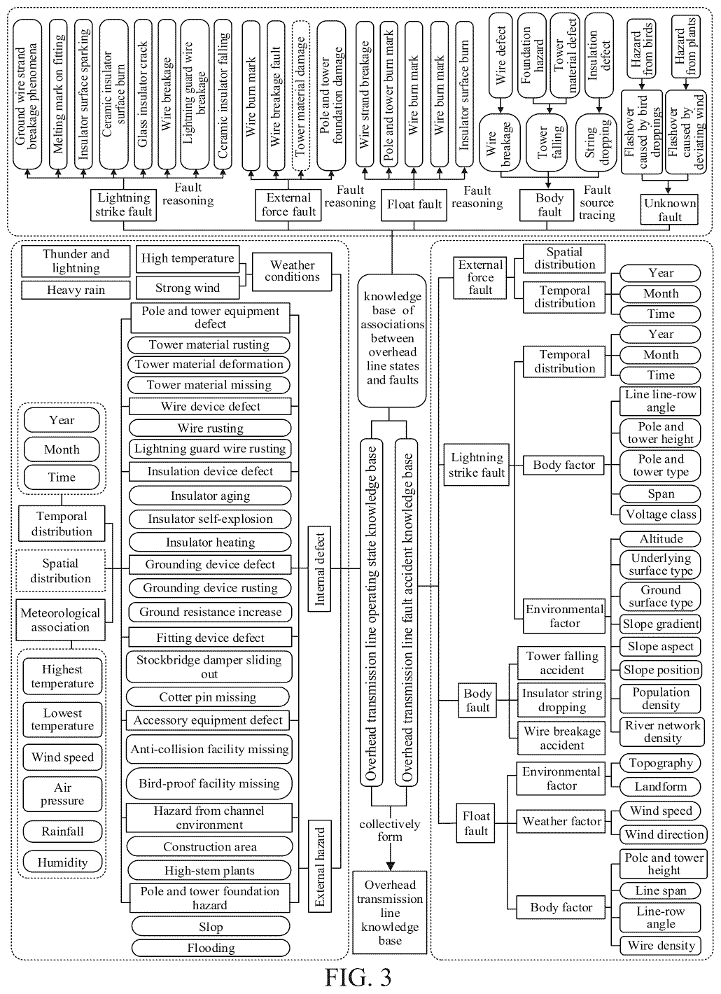

The above three knowledge bases may be fused to form a knowledge base of associations between the operating states and faults of a power system main device. In an example of an overhead power transmission line and an oil-filled distribution transformer, a schematic diagram is shown in FIG. 3. The associations between operating features and fault phenomena of existing power system knowledge is encoded in the knowledge base. Information in FIG. 3 is encoded into a dense vector to achieve dynamic embedding into a continuous vector space, so that pre-training of the neural network models can be performed.

In operation 103, a convolutional base and a classifier of the initial data-driven model are optimized by using historical collected data, to obtain an optimized data-driven model.

Optionally, the operation that a convolutional base and a classifier of the initial data-driven model are optimized by using historical collected data, to obtain an optimized data-driven model, includes that:
the historical collected data is preprocessed, and the historical collected data is divided into a training set and a validation set based on a preset ratio; and
the convolutional base and the classifier of the initial data-driven model are optimized by using the training set, and a validation is performed by using the validation set to construct the data-driven model.

Specifically, referring to FIG. 2, for constructing the tight-coupling hybrid data-driven model on the basis of the embedding of the knowledge bases of the power system main device, that is, during the construction of the data-driven model using collected data: the knowledge base of the oil-filled distribution transformer is converted into the density vector first, and the density vector is embedded into the first layer of the ConvGRU network to complete pre-training of the model; and then the convolutional base and the classifier of pre-trained data are fine-tuned on the basis of the historical collected data.

The preprocessing of the historical collected data: abnormal data of the following three cases is mainly processed:
a. Data anomalies caused by data transmission: peak and valley data resulting from transmission link perturbation or transmission errors. This data cannot truly reflect the state of the physical device.
b. Data anomalies caused by special events: Data anomalies caused by that extreme weather causes collected data to exceed limits of sensors. This data also cannot reflect the actual state of the physical device.
c. Collected data missing caused by communication problems: referring to the problems of poor data transmission reliability, missing of data of key points, etc., in collection of power distribution grid data.

For the above two types of typical abnormal data, the present disclosure performs data complementation by using a generative adversarial imputation neural network (GAIN):
a. Generator (G): estimating a missing component and outputting a complete vector.
b. Discriminator (D): taking the complete vector and attempting to find a specific complement component, thereby forcing the generator to generate data sequences that approximate to the real distribution.

Division of the training set and the validation set: considering the requirement on modeling accuracy, in the present disclosure, it is considered that a data division method that increases the ratio of the validation set is used. That is, the sequence set uses 70% of the data, and the validation set uses 30% of the data.

ConvGRU network structure based on overhead distribution line knowledge base fusion: a fusion layer may map the associations, as a sequence, between the operating states and faults to the real vector domain. An embedded representation with the shape of 200×200 is then fed into a one-dimensional convolutional layer having 100 convolution kernels, the kernel size being four. An output of each conv layer is transmitted to a dropout layer. The conv layer convolves an input feature space into a 200×200 representation and then further performs downsampling along a 1D max pooling layer (MPL) of a pool size with the number of embedding dimensions being four, to produce a shape output of 50×200. Each of the 50 dimensions can be considered as an extracted feature. The MPL flattens an output space by taking a maximum value in each time step dimension, to generate a 1×200 vector including implicit features. A most influential feature is input into a fully connected layer through another dropout layer, and finally a probability distribution of classes is generated through a softmax layer.

In operation 104, the data-driven model and a mechanism model of the power system main device are caused to operate cooperatively in parallel, and a gradient descent of a neural network loss function is performed by using a solver to construct a digital twin hybrid model of the power system main device.

The mechanism model of the power system main device uses the existing physical formulas related to the oil-filled distribution transformer, specifically including: a heat source formula, a heat transfer formula, and a transformer fluid temperature field-flow field coupling formula.

The heat source formula includes: iron core loss and high and low voltage winding loss.

The heat transfer formula includes: a heat conduction formula, a convective heat transfer formula, and a heat radiation formula.

The transformer fluid temperature field-flow field coupling formula includes: a fluid mass conservation equation, a fluid axial momentum conservation equation, a fluid radial momentum conservation equation, a fluid energy conversation equation, and a no-slip boundary condition.

Therefore, since the conventional mechanism model cannot model the dynamic implicit association factor during device operation, a real-time simulation result may be inaccurate. The method for constructing the hybrid model on the basis of the ConvGRU neural network provided in the present disclosure includes associations between implicit features in collected data of device and fault phenomena, thereby improving the dynamic inference capability of the digital twin system in a multi-space multi-scenario within a range of conditions for probability distributions covered by the data.

Optionally, the method further includes that:
a shape parameter of each device in the mechanism model is corrected based on actually measured parameters of the power system main device; and
each internal parameter in the mechanism model is corrected based on the actually measured parameters; herein, the internal parameter includes an iron core full current of an oil-filled distribution transformer, a clamp grounding current, a transformer insulation bushing capacitance, a dielectric loss factor, and error rates of a gas sensor, an oil chromatograph, and a temperature sensor.

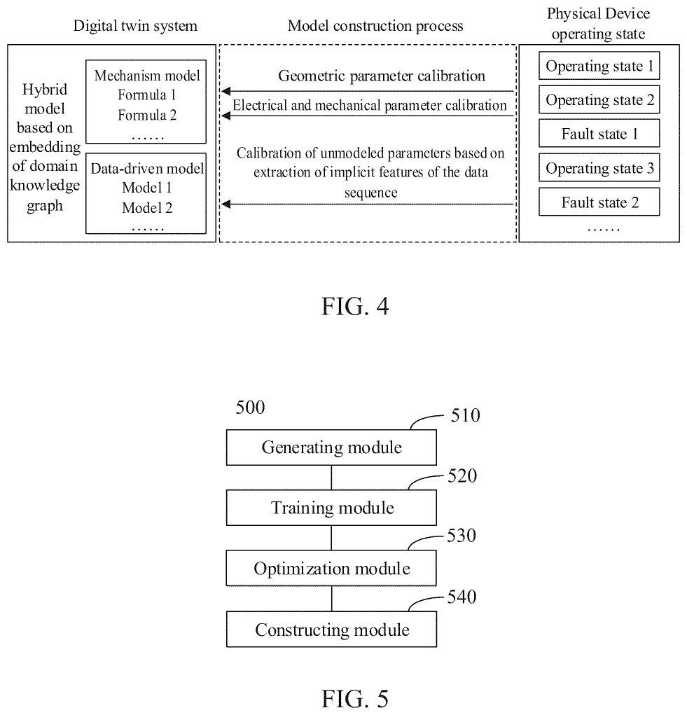

Specifically, referring to FIG. 4, construction of the digital twin hybrid model includes four operations:
1. Geometric parameter calibration: the shape parameter of each device in the mechanism model is corrected by using the actually measured parameters. The shape parameter of the device include dimensions of a main body of the oil-filled distribution transformer, individual pipelines, bushings, and separation tanks, and the like.
2. Electrical and mechanical parameter calibration: each parameter in the mechanism model is corrected based on the actually measured parameters. The parameter include an iron core full current of an oil-filled distribution transformer, a clamp grounding current, a transformer insulation bushing capacitance, a dielectric loss factor, and error rates of a gas sensor, an oil chromatograph, a temperature sensor, etc.
3. Calibration of unmodeled parameters based on extraction of implicit features of the data sequence: the ConvGRU neural network parameters are trained by using a historical operation data sequence of the filled distribution transformer; and the model is used for calibration of an unmodeled parameter, and then combined with the mechanism model in a next operation to form the digital twin hybrid model.
4. Hybrid model assembly: the data-driven model that the knowledge bases of the power system main device are embedded into and that is based on the ConvGRU neural network is connected in parallel to the mechanism model, and parameter updating and minimization of overall loss are performed through the solver to complete construction of the hybrid model.

Thus, beneficial effects of the present disclosure are as follows:
1. The modeling precision is improved: according to the method provided in the present disclosure, the associations between the implicit states of the device and the fault phenomena can be found in both the horizontal and vertical dimensions in the historical collected data. Herein, the horizontal dimension refers to performing local relationship mining on the multi-source heterogeneous data collected by the power device sensor in the same time slice, and the vertical dimension refers to mining of the overall relationship of the implicit features in the data sequence. Therefore, in practical applications, the model trained based on the above method can perform multi-class prediction of possible fault phenomena based on the data sequence collected in real time. When a prediction deviation exceeds a preset threshold, the related data may be re-added to the dataset to iteratively train the neural network model. Compared with the conventional simulation mechanism model relying on the physical formulas or the mathematical formulas, this modeling method can fit the associations between any operating states and fault phenomena, thereby forming an effective complement to the mechanism model, and improving modeling precision by expanding a modeling range.
2. The success rate of construction of the data-driven model is improved: in the method for dynamically constructing a hybrid model on the basis of embedding of power system knowledge bases provided in the present disclosure, the data-driven model generated via the ConvGRU neural network with reference to the data collected in real time, the mechanism model and the data-driven model are combined; by converting the nodes and relationships in the knowledge bases into the density vector, embedding them into the Conv convolutional network, and using the knowledge vector to complete the pre-training of the model, the convolutional base and the classifier are fine-tuned by using the historical collected data, thereby improving the success rate of construction of the data-driven model.
3. Inference prediction accuracy is improved: since the conventional mechanism model cannot model the dynamic implicit association factor during device operation, a real-time simulation result may be inaccurate. The method for constructing the hybrid model on the basis of the ConvGRU neural network provided in the present disclosure includes associations between implicit features in collected data of device and fault phenomena, thereby improving the dynamic inference capability of the digital twin system in a multi-space multi-scenario within a range of conditions for probability distributions covered by the data.

### Exemplary Apparatus

FIG. 5 is a schematic structural diagram of an apparatus for constructing a digital twin hybrid model of a power system main device according to an exemplary embodiment of the present disclosure. As shown in FIG. 5, the apparatus 500 includes a generating module 510, a training module 520, an optimization module 530 and a constructing module 540.

The generating module 510 is configured to generate a density vector by encoding information of a knowledge graph of associations between operating states and faults of a power system main device.

The training module 520 is configured to embed the density vector into a first layer of a ConvGRU network to perform initial training of a data-driven model, to obtain an initial data-driven model.

The optimization module 530 is configured to optimize a convolutional base and a classifier of the initial data-driven model by using historical collected data, to obtain an optimized data-driven model.

The constructing module 540 is configured to cause the data-driven model and a mechanism model of the power system main device to operate cooperatively in parallel, and perform a gradient descent of a neural network loss function by using a solver to construct a digital twin hybrid model of the power system main device.

Optionally, the apparatus 500 further includes a fusion module.

The fusion module is configured to fuse a knowledge base of operating states of the power system main device, a knowledge base of fault accidents of the power system main device, and a knowledge base of intrinsic associations between operating states and fault accidents of the power system main device, to form a knowledge graph of associations between the operating states and faults.

Optionally, the training module 520 includes a training sub-module.

The training sub-module is configured to embed the density vector into the first layer of the ConvGRU neural network by using a ComplEx embedding model to perform the initial training of the data-driven model to obtain the initial data-driven model.

Optionally, the optimization module 530 includes a preprocessing sub-module and an optimization sub-module.

The preprocessing sub-module is configured to preprocess the historical collected data, and divide the historical collected data into a training set and a validation set based on a preset ratio.

The optimization sub-module is configured to optimize the convolutional base and the classifier of the initial data-driven model by using the training set, and perform verification by using the validation set to construct the data-driven model.

Optionally, the apparatus 500 further includes a first correction module and a second correction module.

The first correction module is configured to correct a shape parameter of each device in the mechanism model based on actually measured parameters of the power system main device.

The second correction module is configured to correct each internal parameter in the mechanism model based on actually measured parameters, herein, the internal parameter includes an iron core full current of an oil-filled distribution transformer, a clamp grounding current, a transformer insulation bushing capacitance, a dielectric loss factor, and error rates of a gas sensor, an oil chromatograph, and a temperature sensor.

### Exemplary Electronic Device

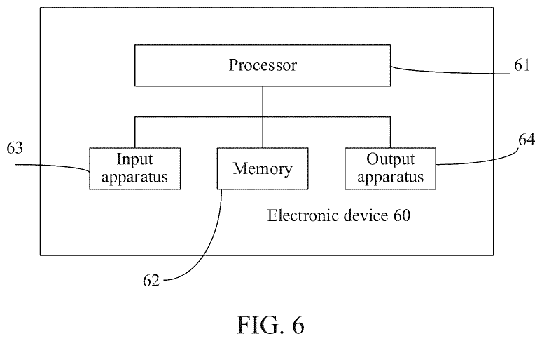

FIG. 6 is a structure of an electronic device according to an exemplary embodiment of the present disclosure. As shown in FIG. 6, the electronic device 60 includes one or more processors 61 and a memory 62.

The processor 61 may be a central processing unit (CPU) or a processing unit in another form having the data processing capability and/or the instruction execution capability, and may control other components in the electronic device to implement expected functions.

The memory 62 may include one or more computer program products, which may include computer-readable storage media in various forms, such as a volatile memory and/or a non-volatile memory. The volatile memory may include, for example, a random access memory (RAM) and/or a cache, etc. The non-volatile memory may include, for example, a read-only memory (ROM), a hard disk, a flash memory, etc. One or more computer program instructions may be stored on the computer-readable storage medium and executed by the processor 61 to implement the methods of the software programs of the various embodiments of the present disclosure described above and/or other expected functions. In one example, the electronic device may further include: an input apparatus 63 and an output apparatus 64. These components are interconnected by means of a bus system and/or a connection mechanism (not shown) in another form.

In addition, the input apparatus 63 may also include, for example, a keyboard, a mouse, etc.

The output apparatus 64 can output various information to the outside. The output apparatus 64 may include, for example, a display, a speaker, a printer, a communication network, and a remote output device connected thereto, etc.

Certainly, for simplification, only some of the components related to the present disclosure in the electronic device are shown in FIG. 6, and components such as a bus, input/output interfaces, and the like are omitted. In addition, the electronic device may also include any other suitable component depending on the specific application.

### Exemplary Computer Program Products and Computer-Readable Storage Media

In addition to the methods and apparatus described above, an embodiment of the present disclosure may also be a computer program product including computer program instructions. The computer program instructions, when executed by a processor, cause the processor to perform the operations in the methods according to various embodiments of the present disclosure described in the above “Exemplary Methods” section of the present specification.

For the computer program product, program code for performing operations of the embodiments of the present disclosure may be written via any combination of one or more programming languages. The programming languages include object-oriented programming languages, such as Java, C++, etc., and further include conventional procedural programming languages, such as the “C” language or similar programming languages. The program code can be executed entirely or partly on a user computer device, executed as a stand-alone software package, executed partly on a user computer device and partly on a remote computer device, or executed entirely on a remote computer device or server.

In addition, an embodiment of the present disclosure may also be a computer-readable storage medium storing computer program instructions. The computer program instructions, when executed by a processor, cause the processor to perform the operations in the method of performing information mining on historical change records according to various embodiments of the present disclosure described in the above “Exemplary Methods” section of the present specification.

The computer-readable storage medium may be any combination of one or more readable media. The readable medium may be a readable signal medium or a readable storage medium. The readable storage medium may include, but is not limited to, an electronic, magnetic, optical, electromagnetic, infrared, or semiconductor system, system, or device, or any combination thereof. More specific examples (a non-exhaustive list) of the readable storage medium include: an electrical connection having one or more wires, a portable disk, a hard disk, a random access memory (RAM), a read only memory (ROM), an erasable programmable read-only memory (an EPROM or a flash memory), an optical fiber, a portable compact disk read-only memory (CD-ROM), an optical storage device, a magnetic storage device, or any suitable combination thereof.

The basic principles of the present disclosure have been described above with reference to specific embodiments. However, it should be noted that the merits, advantages, effects, and the like mentioned in the present disclosure are merely exemplary rather than restrictive, and cannot be considered to be essential to the respective embodiments of the present disclosure. In addition, the specific details disclosed above are merely for the purpose of illustration and easy understanding and are not intended to be restrictive, and the details described above do not mean that the present disclosure must be implemented by using the specific details described above.

The embodiments of the present specification are described in a progressive manner, and each embodiment focuses on the difference from other embodiments. The same or similar parts of the embodiments can be referred to each other. The system embodiment is described relatively briefly because it substantially corresponds to the method embodiments, and for related parts, reference may be made to the method embodiments.

The block diagrams of the devices, systems, apparatuses, and systems involved in the present disclosure are merely illustrative examples and are not intended to require or imply that the connections, arrangements, and configurations must be performed in the manner shown in the block diagrams. These devices, systems, apparatuses, and systems may be connected, arranged, and configured in any manner, as will be recognized by those skilled in the art. Terms such as “comprising”, “including”, “having”, and the like are open-ended words that mean “including but not limited to” and can be used interchangeably therewith. As used herein, the terms “or” and “and” refer to the term “and/or”, and can be used interchangeably therewith unless the context clearly indicates otherwise. As used herein, the term “such as” refers to “such as, but not limited to”, and can be used interchangeably therewith.

The methods and systems of the present disclosure may be implemented in many manners. For example, the methods and systems of the present disclosure may be implemented via software, hardware, firmware, or any combination of software, hardware, and firmware. The above-described order for the operations the method is for illustration only, and the operations of the method of the present disclosure are not limited to the order specifically described above, unless specifically indicated otherwise. Furthermore, in some embodiments, the present disclosure may also be implemented as programs recorded in a recording medium, the programs including machine-readable instructions for implementing the method according to the present disclosure. Thus, the present disclosure also covers a recording medium storing a program for performing the method according to the present disclosure.

It should also be noted that in the systems, devices, and methods of the present disclosure, components or steps may be decomposed and/or recombined. These decompositions and/or recombinations should be regarded as equivalent solutions of the present disclosure. The above description of the disclosed aspects is provided to enable any person skilled in the art to make or use the present disclosure. Various modifications to these aspects will be readily apparent to those skilled in the art, and the generic principles defined herein may be applied to other aspects without departing from the scope of the present disclosure. Thus, the present disclosure is not intended to be limited to the aspects shown herein but is to be accorded to the widest scope consistent with the principles and novel features disclosed herein.

The foregoing description has been provided for the purposes of illustration and description. Furthermore, the description is not intended to limit the embodiments of the present disclosure to the form disclosed herein. Although a number of exemplary aspects and embodiments have been discussed above, those skilled in the art will recognize certain variations, modifications, changes, additions and sub-combinations thereof.

### Industrial Applicability

The method and apparatus for constructing a digital twin hybrid model of a power system main device are provided in the embodiments of the present disclosure. The method includes that: a density vector is generated by encoding information of a knowledge graph of associations between operating states and faults of a power system main device; the density vector is embedded into a first layer of a ConvGRU network to perform initial training of a data-driven model to obtain an initial data-driven model; a convolutional base and a classifier of the initial data-driven model are optimized by using historical collected data to obtain an optimized data-driven model; and the data-driven model and a mechanism model of the power system main device are caused to operate cooperatively in parallel, and a gradient descent of a neural network loss function is performed by using a solver to construct a digital twin hybrid model of the power system main device. This modeling method can fit the associations between any operating states and fault phenomena, thereby forming an effective complement to the mechanism model, and improving modeling precision by expanding a modeling range. The convolutional base and the classifier are fine-tuned by using the historical collected data, thereby improving the success rate of construction of the data-driven model. The modeling method includes associations between implicit features in collected data of device and fault phenomena, thereby improving the dynamic inference capability of the digital twin system in a multi-space multi-scenario within a range of conditions for probability distributions covered by the data.

1. A method for constructing a digital twin hybrid model of a power system main device, comprising:
generating a density vector by encoding information of a knowledge graph of associations between operating states and faults of the power system main device;
embedding the density vector into a first layer of a ConvGRU network to perform initial training of a data-driven model to obtain an initial data-driven model;
optimizing a convolutional base and a classifier of the initial data-driven model by using historical collected data to obtain an optimized data-driven model; and
causing the data-driven model and a mechanism model of the power system main device to operate cooperatively in parallel, and performing a gradient descent of a neural network loss function by using a solver to construct the digital twin hybrid model of the power system main device.

2. The method according to claim 1, further comprising:
fusing a knowledge base of the operating states of the power system main device, a knowledge base of fault accidents of the power system main device, and a knowledge base of intrinsic associations between the operating states and the fault accidents of the power system main device to form the knowledge graph of the associations between the operating states and the faults.

3. The method according to claim 1, wherein the operation of embedding the density vector into the first layer of the ConvGRU network to perform the initial training of the data-driven model to obtain the initial data-driven model comprises:
embedding the density vector into the first layer of the ConvGRU network by using a ComplEx embedding model to perform the initial training of the data-driven model to obtain the initial data-driven model.

4. The method according to claim 1, wherein the operation of optimizing the convolutional base and the classifier of the initial data-driven model by using the historical collected data to obtain the optimized data-driven model comprises:
preprocessing the historical collected data, and dividing the historical collected data into a training set and a validation set based on a preset ratio; and
optimizing the convolutional base and the classifier of the initial data-driven model by using the training set, and performing a verification by using the validation set to construct the data-driven model.

5. The method according to claim 1, further comprising:
correcting a shape parameter of each device in the mechanism model based on actually measured parameter of the power system main device; and
correcting each internal parameter in the mechanism model based on the actually measured parameters, wherein the internal parameter comprises an iron core full current of an oil-filled distribution transformer, a clamp grounding current, a transformer insulation bushing capacitance, a dielectric loss factor, and error rates of a gas sensor, an oil chromatograph, and a temperature sensor.

6. An apparatus for constructing a digital twin hybrid model of a power system main device, comprising:
a processor; and
a memory for storing instructions executable by the processor,
wherein the processor is configured to:
generate a density vector by encoding information of a knowledge graph of associations between operating states and faults of the power system main device;
embed the density vector into a first layer of a ConvGRU network to perform initial training of a data-driven model to obtain an initial data-driven model;
optimize a convolutional base and a classifier of the initial data-driven model by using historical collected data to obtain an optimized data-driven model; and
cause the data-driven model and a mechanism model of the power system main device to operate cooperatively in parallel, and perform a gradient descent of a neural network loss function by using a solver to construct the digital twin hybrid model of the power system main device.

7. The apparatus according to claim 6, wherein the processor is further configured to:
fuse a knowledge base of the operating states of the power system main device, a knowledge base of fault accidents of the power system main device, and a knowledge base of intrinsic associations between the operating states and the fault accidents of the power system main device to form the knowledge graph of the associations between the operating states and the faults.

8. The apparatus according to claim 6, wherein the processor is further configured to:
embed the density vector into the first layer of the ConvGRU neural network by using a ComplEx embedding mode to perform the initial training of the data-driven model to obtain the initial data-driven model.

9. A non-transitory computer-readable storage medium, wherein the non-transitory computer-readable storage medium stores a computer program, and the computer program is used to perform a method for constructing a digital twin hybrid model of a power system main device, wherein the method comprises:
generating a density vector by encoding information of a knowledge graph of associations between operating states and faults of the power system main device;
embedding the density vector into a first layer of a ConvGRU network to perform initial training of a data-driven model to obtain an initial data-driven model;
optimizing a convolutional base and a classifier of the initial data-driven model by using historical collected data to obtain an optimized data-driven model; and
causing the data-driven model and a mechanism model of the power system main device to operate cooperatively in parallel, and performing a gradient descent of a neural network loss function by using a solver to construct the digital twin hybrid model of the power system main device.

10. (canceled)

11. The apparatus according to claim 6, wherein the processor is further configured to:
preprocess the historical collected data, and divide the historical collected data into a training set and a validation set based on a preset ratio; and
optimize the convolutional base and the classifier of the initial data-driven model by using the training set, and perform a verification by using the validation set to construct the data-driven model.

12. The apparatus according to claim 6, wherein the processor is further configured to:
correct a shape parameter of each device in the mechanism model based on actually measured parameter of the power system main device; and
correct each internal parameter in the mechanism model based on the actually measured parameters, wherein the internal parameter comprises an iron core full current of an oil-filled distribution transformer, a clamp grounding current, a transformer insulation bushing capacitance, a dielectric loss factor, and error rates of a gas sensor, an oil chromatograph, and a temperature sensor.

13. The non-transitory computer-readable storage medium according to claim 9, wherein the method further comprises:
fusing a knowledge base of the operating states of the power system main device, a knowledge base of fault accidents of the power system main device, and a knowledge base of intrinsic associations between the operating states and the fault accidents of the power system main device to form the knowledge graph of the associations between the operating states and the faults.

14. The non-transitory computer-readable storage medium according to claim 9, wherein the operation of embedding the density vector into the first layer of the ConvGRU network to perform the initial training of the data-driven model to obtain the initial data-driven model comprises:
embedding the density vector into the first layer of the ConvGRU network by using a ComplEx embedding model to perform the initial training of the data-driven model to obtain the initial data-driven model.

15. The non-transitory computer-readable storage medium according to claim 9, wherein the operation of optimizing the convolutional base and the classifier of the initial data-driven model by using the historical collected data to obtain the optimized data-driven model comprises:
preprocessing the historical collected data, and dividing the historical collected data into a training set and a validation set based on a preset ratio; and
optimizing the convolutional base and the classifier of the initial data-driven model by using the training set, and performing a verification by using the validation set to construct the data-driven model.

16. The non-transitory computer-readable storage medium according to claim 9, wherein the method further comprises:
correcting a shape parameter of each device in the mechanism model based on actually measured parameter of the power system main device; and
correcting each internal parameter in the mechanism model based on the actually measured parameters, wherein the internal parameter comprises an iron core full current of an oil-filled distribution transformer, a clamp grounding current, a transformer insulation bushing capacitance, a dielectric loss factor, and error rates of a gas sensor, an oil chromatograph, and a temperature sensor.
